(19) United States
(12) Patent Application Publication
(10) Pub. No.: US 2025/0223842 A1
(43) Pub. Date: Jul. 10, 2025

(54) OVERHEAD DOOR LOCKING DEVICE

(71) Applicant: The Parts Department Ltd., Moffat (CA)

(72) Inventor: Bill English, Moffat (CA)

(21) Appl. No.: 18/404,074

(22) Filed: Jan. 4, 2024

(51) Int. Cl. E05B 65/00

(52) U.S. Cl. CPC E05B 65/0021

(57) ABSTRACT

An overhead door locking device and method are disclosed, the device comprising a housing; a gear; two plates, each comprising a cut-out triangular pivot point; a double-headed pawl disposed between the two plates, the double-headed pawl engageable with the gear and each cut-out triangular pivot point; and a release mechanism.

### FIELD

The present specification relates generally to overhead doors and more specifically to an overhead door locking device.

### BACKGROUND

Overhead doors, such as garage doors, currently employ various raising and lowering mechanisms. However, a number of these mechanisms lack the capability of locking the overhead door in in a fixed position. This is problematic if a door needs to be held open for re-entry or re-exit, or if a user desires that the door be left in a semi-raised position, for the purposes of ventilation between outdoors and indoors, for example. An overhead door that slides out of its desired position also poses a safety risk to adults, children, or animals that are passing underneath it. Similarly, an overhead door that slides out of position can cause property damage, for example if it slides down on a piece of equipment or vehicle that is left underneath it, it could damage a user's property, or damage the door.

Some solutions do exist for locking an overhead door in a desired position. However, these solutions employ a multiplicity of moving parts such as springs, deadbolts, multiple pawls or ratchets, or hydraulics. The number of moving parts results in an increased potential for damage, complications, and therefore expense. Further, many of these solutions do not lock automatically, and rely on a user remembering to lock the door in a desired position. This is problematic, especially if expensive goods are stored behind an overhead door, and a user forgets to engage the lock. The role of human error in existing solutions results in the opportunity for theft, or even injury, thereby increasing a user's liability.

### SUMMARY

In an embodiment of the present invention, there is provided an overhead door locking device, comprising: a housing; a gear; two plates, each comprising a cut-out triangular pivot point; a double-headed pawl disposed between the two plates, the double-headed pawl engageable with the gear and each cut-out triangular pivot point; and a release mechanism.

A method of using an overhead door locking device to secure an overhead door in a desired position comprising: lifting a release mechanism such that a double-headed pawl is pulled upwards, and a pin on the double-headed pawl rises to a top point of a cut-out triangular pivot point; applying force to an overhead door such that the overhead door is pushed upwards or pulled downwards; releasing the release mechanism such that it rests lightly on a rotating gear but does not engage any teeth in the gear; allowing the overhead door to come to a stop, either by exhausting the energy resulting from the applied force, or by holding the overhead door such that it stops in a desired position; allowing the gear to slow to a stop such that the double-headed pawl engages with the teeth of the gear; and allowing the double-headed pawl to be pushed to one side until it abuts a back wall of the cut-out triangular pivot point.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a front plan view of an overhead door locking device without a cover where the double-headed pawl is in a locked position preventing counterclockwise rotation, according to an embodiment;

FIG. 2 is a front plan view of an overhead door locking device without a cover where the double-headed pawl is in a locked position preventing counterclockwise rotation, according to an embodiment;

FIG. 3 is a front plan view of an overhead door locking device without a cover where the double-headed pawl is in a raised position allowing rotation in any direction, according to an embodiment;

FIG. 4 is a back plan view of an overhead door locking device without a cover, according to an embodiment;

FIG. 5 is a left-side perspective view of an overhead door locking device without a cover, according to an embodiment;

FIG. 6 is a right-side perspective view of an overhead door locking device without a cover, according to an embodiment;

FIG. 7 is a top plan view of an overhead door locking device without a cover, according to an embodiment;

FIG. 8 is a bottom plan view of an overhead door locking device without a cover, according to an embodiment;

FIG. 9 is a left-side perspective view of an overhead door locking device without a cover and without one of two plates, according to an embodiment;

FIG. 10 is a right-side perspective view of an overhead door locking device without a cover and without one of two plates, according to an embodiment;

FIG. 11 is a top perspective view of an overhead door locking device with a cover, according to an embodiment;

FIG. 12 is a bottom perspective view of an overhead door locking device with a cover, according to an embodiment;

FIG. 13 is a left-side perspective view of an overhead door locking device with a cover and an operating arm, according to an embodiment.

FIG. 14 is a front plan view of an overhead door locking device without a cover where the double-headed pawl is in a locked position preventing clockwise rotation, according to an embodiment; and

FIG. 15 is a front plan view of an overhead door locking device without a cover where the double-headed pawl is in a locked position preventing clockwise rotation, according to an embodiment.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and, in some instances, proportions may have been exaggerated in order to more clearly depict certain features of the invention.

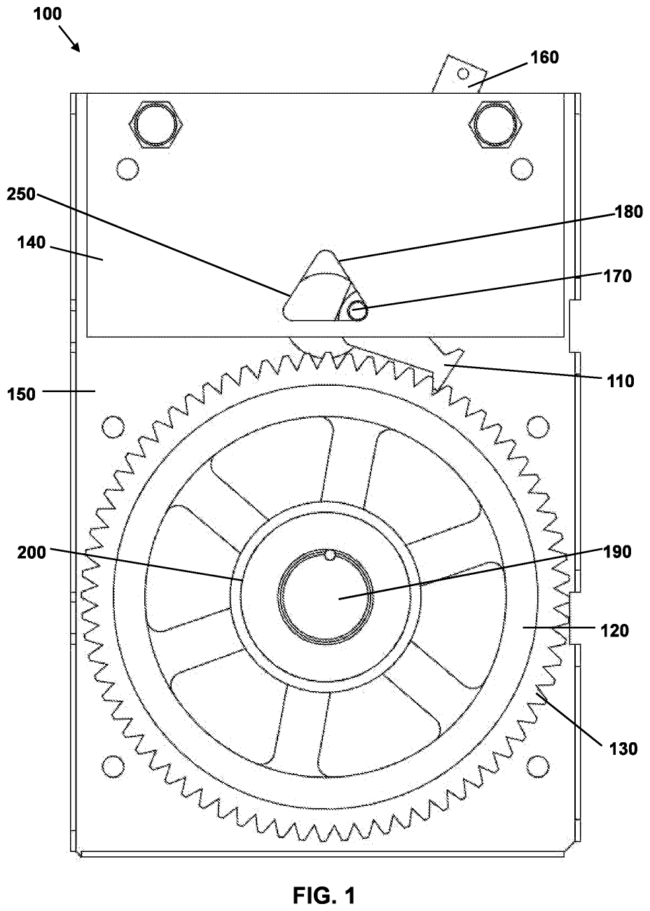

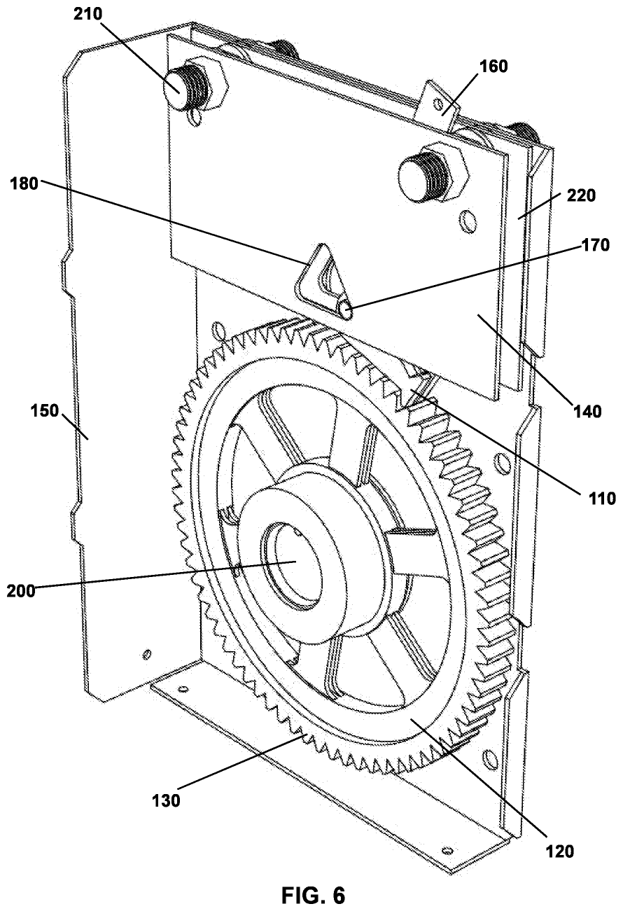

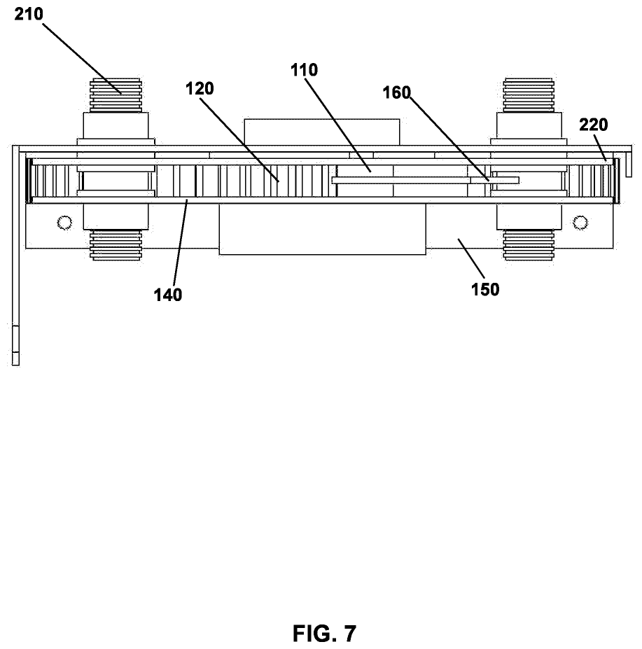

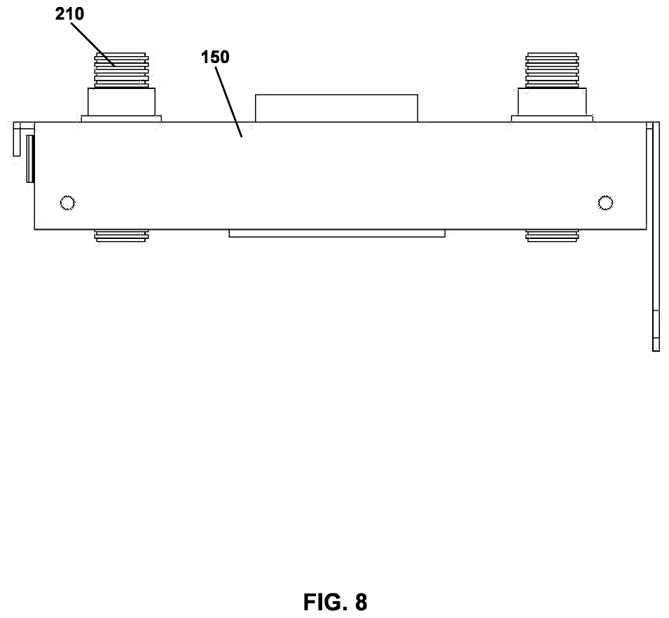

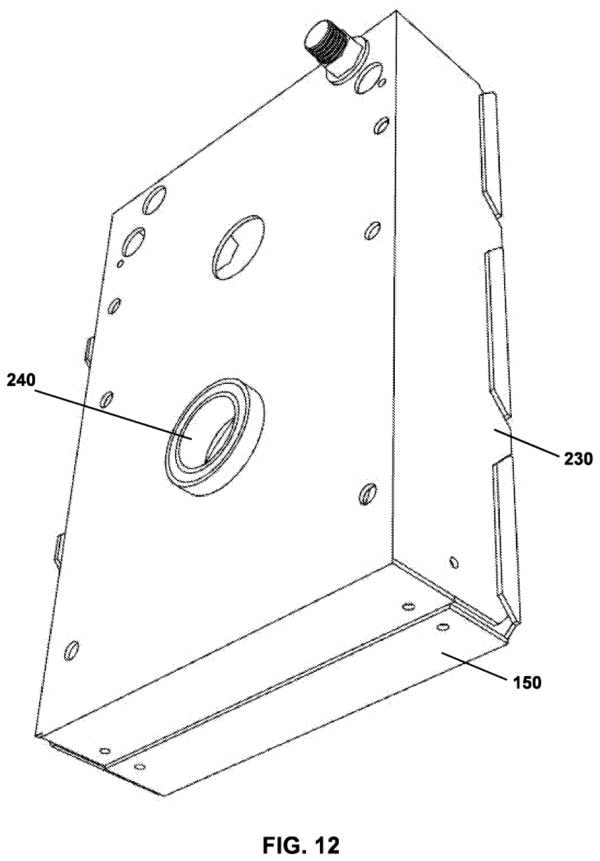

According to an embodiment, as shown in FIGS. 1 to 13, an overhead door locking device 100 is provided to lock an overhead door in a fixed position. Accordingly, overhead door locking device 100 may alleviate safety concerns associated with leaving an overhead door in an open position, namely by eliminating the risk of the overhead door sliding downwards. Further, overhead door locking device may reduce the possibility for robbery or unwanted entry into a space, by automatically locking the overhead door when the overhead door is in a closed position.

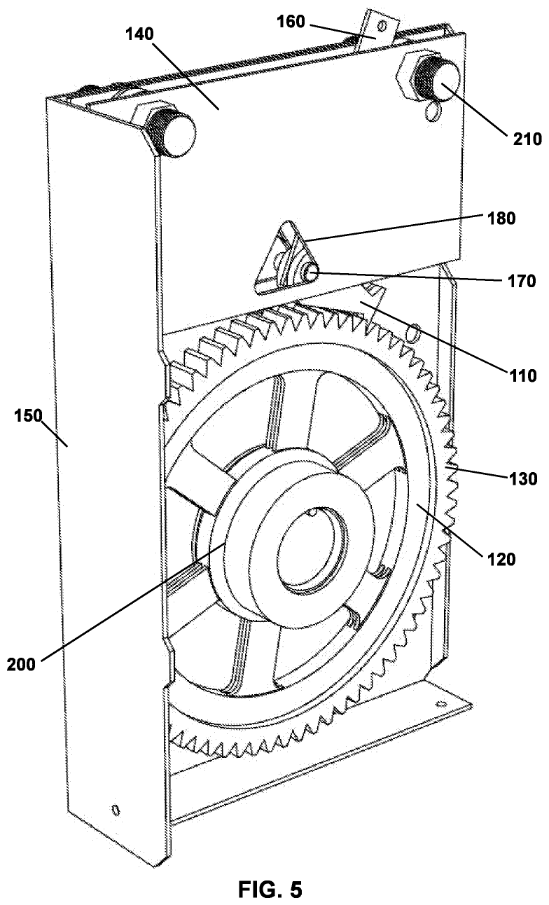

As shown in FIGS. 5 to 8, overhead door locking device, comprises a housing 150, a gear 120, two plates 140 and 220 each comprising a cut-out triangular pivot point 180, a double-headed pawl 110 disposed between two plates 140 and 220, double-headed pawl 110 engageable with gear 120 and each cut-out triangular pivot point 180, and a release mechanism 160, according to an embodiment. Plates 140 and 220 may be attachable to each other and to housing 150 by screws 210. Further, plates 140 and 220 may be attachable to each other and to housing 150 by bolts.

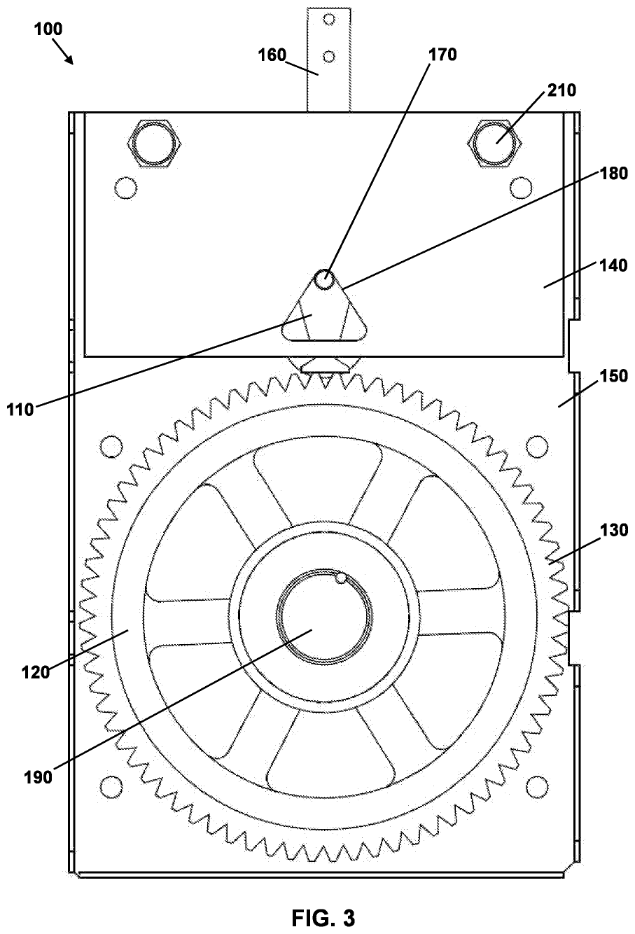

Overhead door locking device may prevent an overhead door shaft from rotating in an opposite direction unless release mechanism 160 has been momentarily activated (e.g., releasing double-headed pawl 110 from engagement with gear 120 such as shown in FIG. 3). Therefore, when an overhead door has been manually pushed upward, it may be automatically prevented from lowering, thereby preventing it from accidentally being impacted from forklift or other vehicle traffic passing through a door opening. This may reduce the risk of damage to an overhead door or possibly injuring a vehicle driver. After momentarily activating release mechanism 160, overhead door locking device 100 will allow an overhead door to be lowered freely and may lock an overhead door in a lowered position, meaning an overhead door may not be raised without releasing release mechanism 160. This may increase the safety associated with the use of overhead doors, in that overhead door locking device 100 may prevent movement through an open doorway. Further, overhead door locking device 100 may also act as a security precaution, in that an overhead door is locked automatically when lowered.

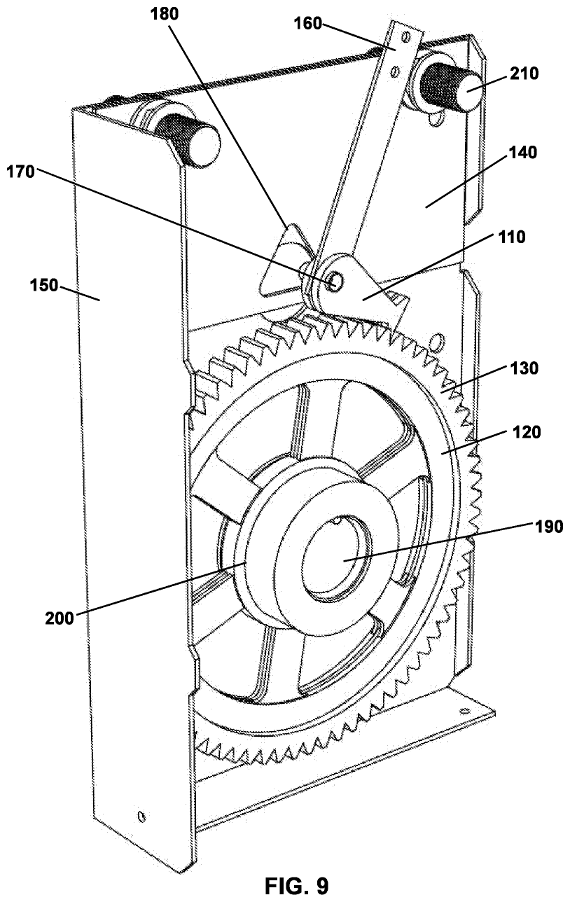

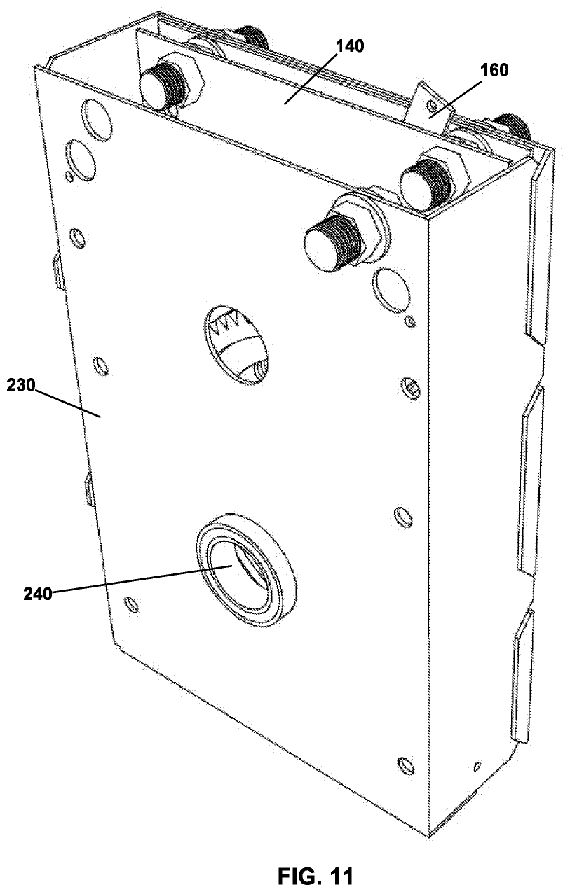

According to an embodiment, as shown in FIGS. 1 and 9, a center of gear 200 aligns with a central hole 190 in a wall of housing 150. Housing 150 may comprise a cover 230, as shown in FIGS. 11 to 13. Cover 230 may be removably attachable by screws 210 or bolts. If cover 230 is used, cover may comprise a central hole 240 in alignment with central hole 190. Central hole 190 and center of gear 200 are slidable onto an overhead door shaft, according to an embodiment. Alignment of central hole 190 and center of gear 200 may allow for simple installation of overhead door locking device 100 onto an overhead door shaft. Housing 150 may comprise metal. Cover 230 may comprise metal.

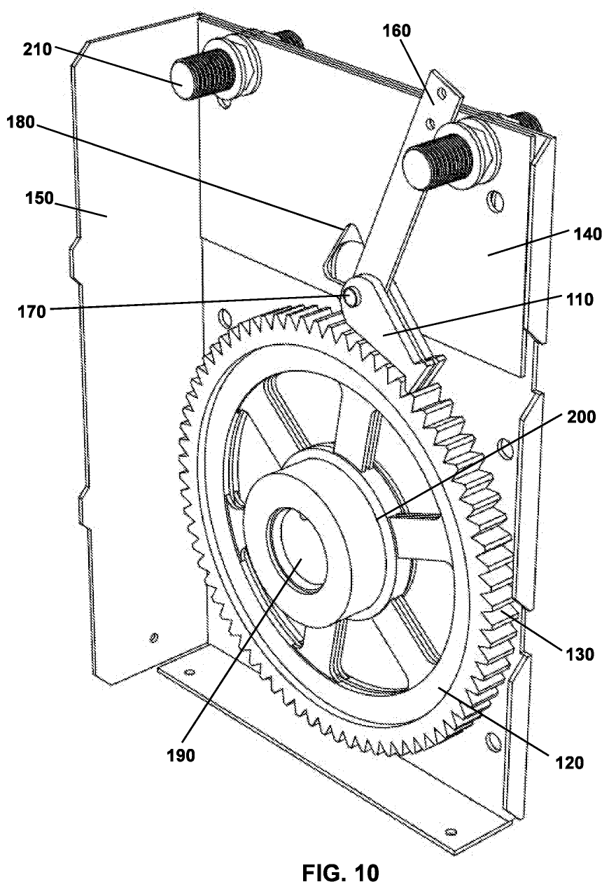

According to an embodiment, release mechanism 160 is attachable to double-headed pawl 110 such that release mechanism 160 is sandwiched between two double-headed pawls 110, as shown in FIGS. 9 and 10. Release mechanism 160 may be attachable to an end of double-headed pawl 110 by screw, nail, or pin 170. These or other ways of attaching double-headed pawl 110 to release mechanism 160 may allow for free rotation of double-headed pawl 110 around release mechanism 160, such that it may engage gear teeth 130 when double-headed pawl 110 is in either a left-leaning or right-leaning position.

According to an embodiment, as shown in FIGS. 1 to 3, cut-out triangular pivot point 180 is located above gear 120. Double-headed pawl 110 is engageable with gear 120 and each cut-out triangular pivot point 180, as shown in FIGS. 1 to 3. According to an embodiment, double-headed pawl 110 comprises a substantially triangular head such that double-headed pawl 110 is symmetrical, as shown in FIGS. 1 to 3. The substantially triangular head may allow for double-headed pawl 110 to engage teeth 130 equally well in two directions, which may prevent gear 120 from rotating in an opposite direction. Double-headed pawl 110 may thereby prevent an overhead door from sliding out of position. Double-headed pawl 110 may comprise metal.

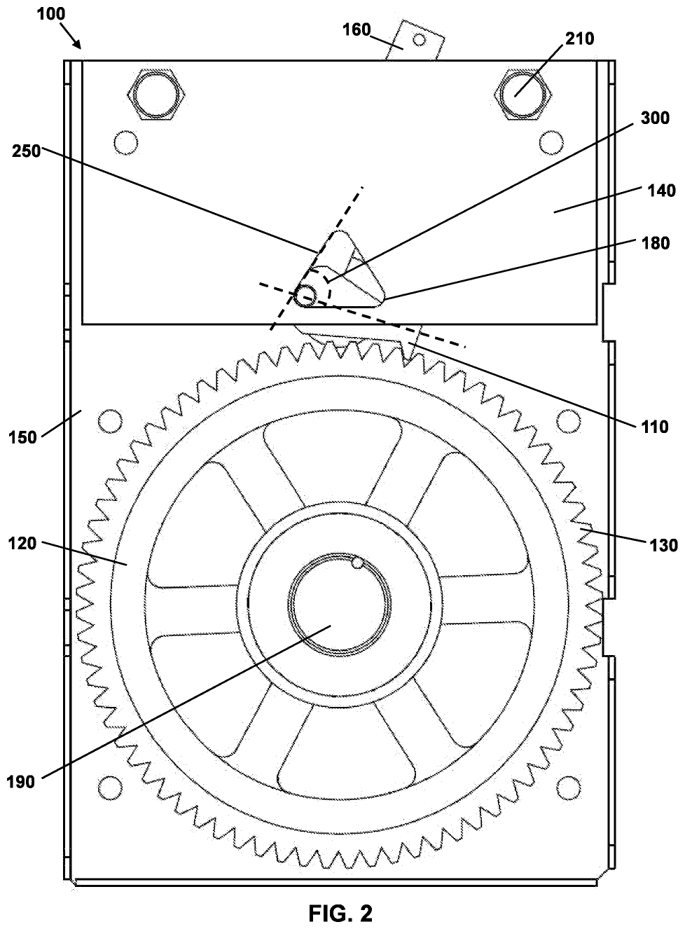

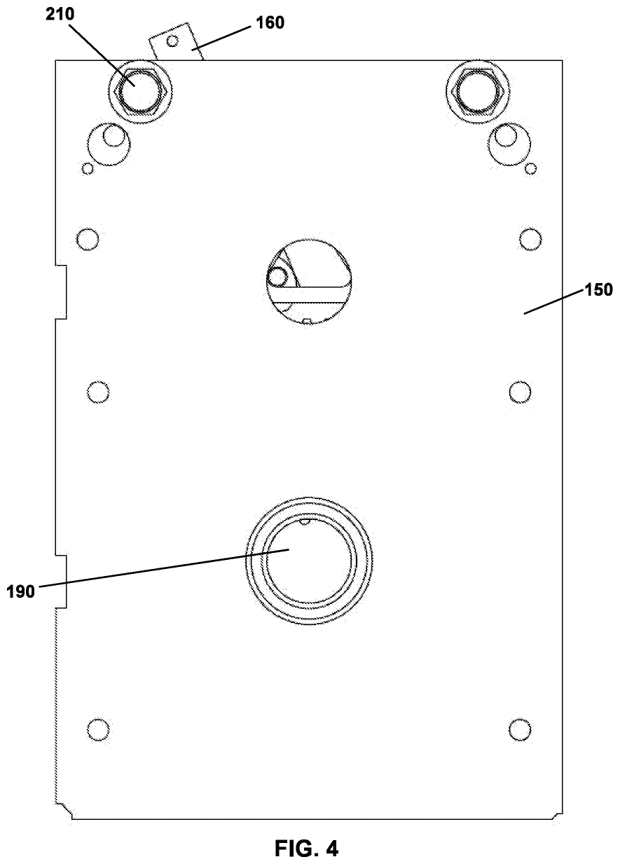

According to an embodiment, as shown in FIGS. 4, 5 and 9, double-headed pawl 110 comprises a connector 170 attachable to double-headed pawl 110. Connector 170 may connect double-headed pawl 110 and release mechanism 160. According to an embodiment, connector 170 extends outwardly from double-headed pawl 110, such that each end of connector 170 contacts cut-out triangular pivot point 180 on one of the two plates 140 and 220. According to an embodiment, as shown in FIGS. 1 and 2, connector 170 is small enough to occupy only a single corner of cut-out triangular pivot point 180. A size of connector 170 may allow for smooth movement of double-headed pawl 110 between locked, unlocked, and raised positions. Contact between connector 170 and cut-out triangular pivot point 180 may allow for controlled movement of double-headed pawl 110 between positions.

According to an embodiment, connector 170 is removable from double-headed pawl 110. Double-headed pawl 110 and connector 170 may comprise metal.

In some embodiments, release mechanism 160 (e.g., including a release arm) has a hole in the end that connector 170 passes through to engage with pawl 110. This allows release arm 160 to pivot within pawl 110. Release mechanism 160 is configured to prevent an overhead door counterbalance shaft from rotating in the opposite direction unless release mechanism 160 has been momentarily activated. This means when the door has been manually pushed upward it automatically is prevented from being unintentionally lowered. This helps prevent the door from accidentally being impacted from forklift traffic passing through the door opening that may cause damage to the door and possibly injuring the driver, for example. After momentarily activating release mechanism 160, release mechanism 160 is configured to allow the door to be lowered freely locking it in a lowered position and preventing it from being able to be raised without using release mechanism 160. This adds a safety aspect preventing movement through an open doorway and also security to a building ensuring that the door is locked and closed automatically when lowered.

According to an embodiment, as shown in FIG. 2, an angle 300 between double-headed pawl 110 and a back wall 250 of cut-out triangular pivot point 180 is less than 90 degrees in a locked position. Double-headed pawl 110 may lock in either a left-leaning or right-leaning position. FIG. 2 shows double-headed pawl 110 locked in a left-leaning position, according to an embodiment. Back wall 250 may be defined in relation to a direction of double-headed pawl 110, such that a side of cut-out triangular pivot point 180 which double-headed pawl 110 abuts in its locked position is considered back wall 250.

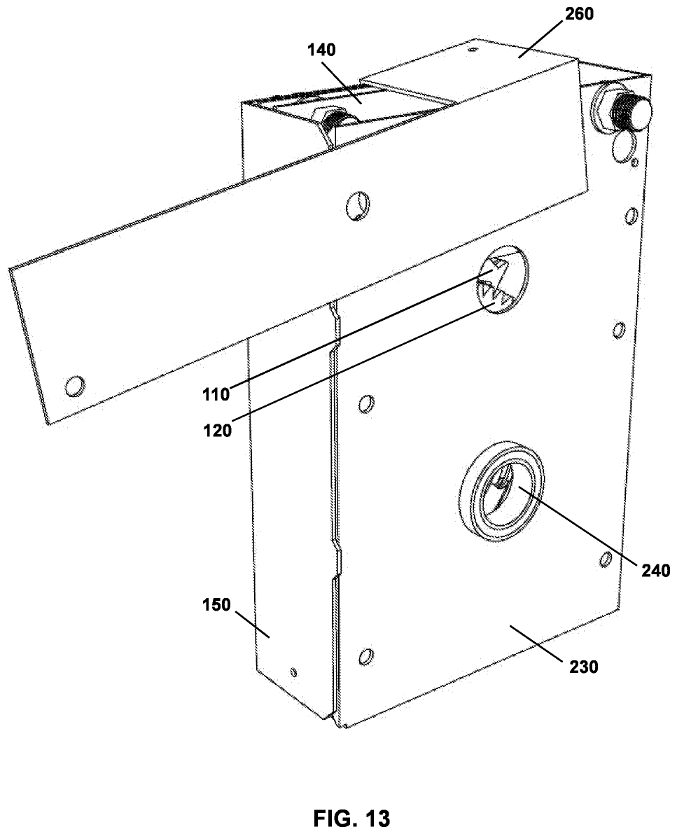

Release mechanism 160 may be used to manually lift double-headed pawl 110 from locked position. According to an embodiment, release mechanism 160 is attachable to an operating arm 260, as shown in FIG. 13. Operating arm 260 may be attachable to a pull-down cable, chain, or handle.

According to an embodiment, there is provided a method of using an overhead door locking device 100 to secure an overhead door in a desired position comprising: lifting release mechanism 160 such that double-headed pawl 110 is pulled upwards, and pin 170 on double-headed pawl 110 rises to a top point of cut-out triangular pivot point 180; applying force to an overhead door such that the overhead door is pushed upwards or pulled downwards; releasing release mechanism 160 such that it rests lightly on a rotating gear 120 but does not engage teeth 130 in gear 120 (e.g., as shown in FIG. 3); allowing the overhead door to come to a stop, either by exhausting the energy resulting from the applied force, or by holding the overhead door such that it stops in a desired position; allowing gear 120 to slow to a stop such that double-headed pawl 110 engages with teeth 130 of gear 120; and allowing double-headed pawl 110 to be pushed to one side until double-headed pawl 110 abuts a back wall 250 of cut-out triangular pivot point 180.

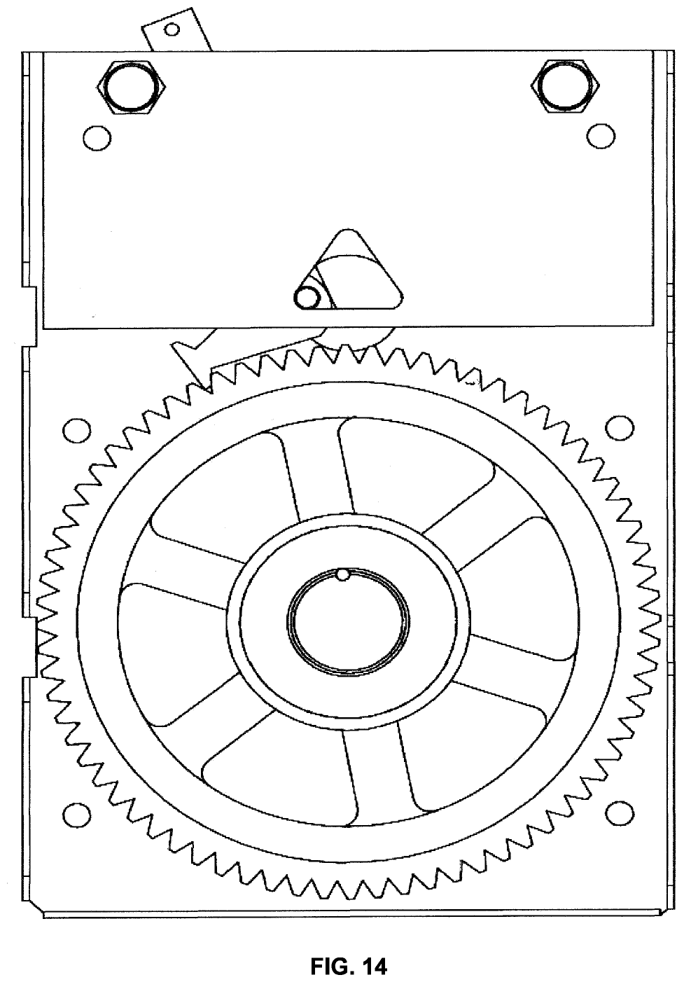

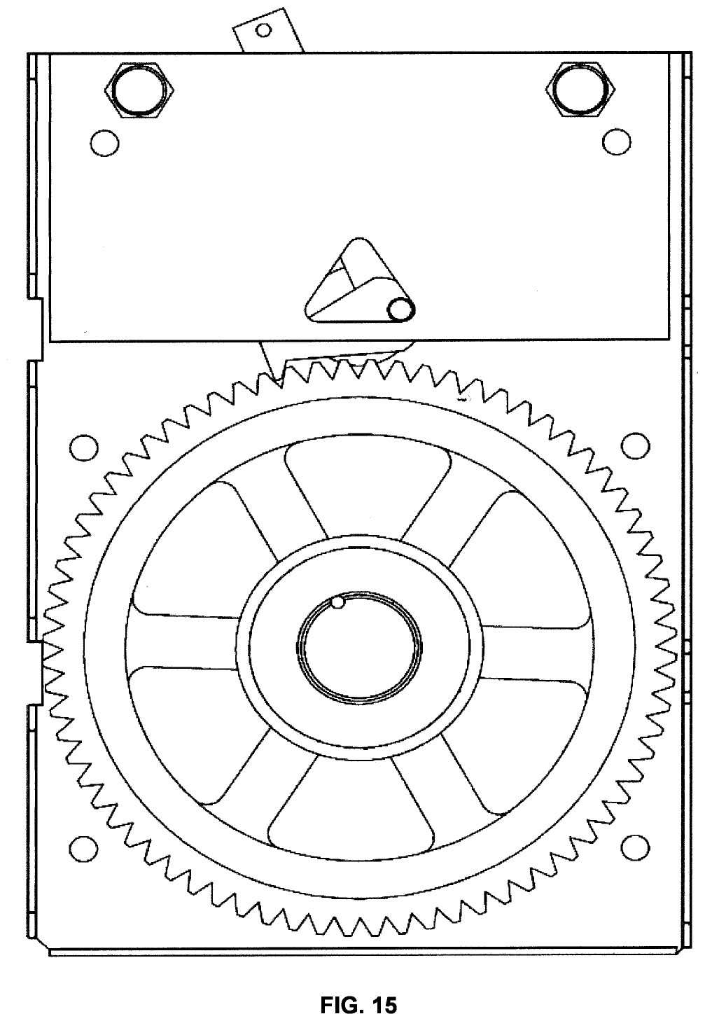

FIGS. 1 to 3 show double-headed pawl 110 in an unlocked position, a locked position, and a raised position, respectively, according to an embodiment. In the embodiment shown in FIG. 1, double-headed pawl 110 is shown in a clockwise rotation and in a locked position where gear 120 is prevented from rotating in a counterclockwise direction. In particular, overhead door locking device 100 is shown in a free rotating clockwise direction. In FIG. 1, double-headed pawl 110 can only move from the configuration shown in FIG. 2 as far as the opposite side of the triangle pivot point allowing gear 120 to move in the opposite direction only slightly before stopping in the configuration shown in FIG. 1. In the embodiment shown in FIG. 2, double-headed pawl 110 is shown in a clockwise rotation and in a locked position where gear 120 is prevented from rotating in a counterclockwise direction past the configuration shown in FIG. 1. In the embodiment shown in FIG. 3, double-headed pawl 110 is raised and gear 120 can rotate in a counterclockwise or clockwise direction. FIG. 14 shows an embodiment where double-headed pawl 110 is shown in a counterclockwise rotation and in a locked position where gear 120 is prevented from rotating in a clockwise direction. In the embodiment shown in FIG. 15, double-headed pawl 110 is shown in a counterclockwise rotation and in a locked position where gear 120 is prevented from rotating in a clockwise direction past the configuration shown in FIG. 14.

In some embodiments, a free counterclockwise rotation is enabled, where the configuration of the double-headed pawl 110 relative to gear 120 is understood to be in a reverse configuration to that shown in FIGS. 1 and 2, with double-headed pawl 110 on the other side of gear 120.

According to an embodiment, as shown in FIG. 13, lifting a release mechanism 160 may comprise a user pulling down on operating arm 260. Pulling down on operating arm 260 may comprise pulling on a cable, chain or handle attachable to operating arm 260.

In an example embodiment, an installation method for overhead door locking device 100 includes sliding housing 150 over the end of a door spring shaft on either side of the door and anchoring a clip from the housing 150 to the wall to prevent the mechanism from rotating with the door shaft. Installation time can be short, such as, approximately 15 minutes, for example.

In an example embodiment, to operate overhead door locking device 100, a user temporarily pulls a release rope connected to a release arm on overhead door locking device 100 that enables the door to be raised manually to the desired open position. Overhead door locking device 100 will not allow the door to be lowered without first using the release rope one more time. This will allow the door to be manually lowered to a closed position. The mechanism controls the reverse rotation of a door spring shaft and can only be released by the release rope.

In some embodiments, overhead door locking device 100 is configured to include a triangular pivot point for a gear pawl. This enables reversing the rotation with a single action and allow control of the spring shaft rotation and manual opening or closing of an overhead door with a single release action. A user can manually open a door securely in an open position, and the when the door is closed, the door is automatically locked in the closed position. Overhead door locking device 100 is configured for use without hydraulic levelers, for example.

Various embodiments of the invention have been described in detail.

What is claimed is:

1. An overhead door locking device, comprising:
a housing;
a gear;
two plates, each comprising a cut-out triangular pivot point;
a double-headed pawl disposed between the two plates, the double-headed pawl engageable with the gear and each cut-out triangular pivot point; and
a release mechanism.

2. The overhead door locking device of claim 1, wherein the housing comprises metal.

3. The overhead door locking device of claim 1, wherein the housing comprises a cover.

4. The overhead door locking device of claim 1, wherein a center of the gear aligns with a central hole in a wall of the housing.

5. The overhead door locking device of claim 4, wherein the central hole and the center of the gear are slidable onto an overhead door shaft.

6. The overhead door locking device of claim 1, wherein the release mechanism is attachable to an end of the double-headed pawl.

7. The overhead door locking device of claim 1, wherein the release mechanism is disposed between two double-headed pawls.

8. The overhead door locking device of claim 1, wherein the cut-out triangular pivot point is located above the gear.

9. The overhead door locking device of claim 1, wherein the double-headed pawl comprises metal.

10. The overhead door locking device of claim 1, wherein the double-headed pawl comprises a substantially triangular head such that the double-headed pawl is symmetrical.

11. The overhead door locking device of claim 7, wherein the release mechanism is attachable to the double-headed pawls by a pin.

12. The overhead door locking device of claim 7, wherein the pin extends outwardly from each of the double-headed pawls, such that each end of the pin contacts one cut-out triangular pivot point.

13. The overhead door locking device of claim 7, wherein the pin is small enough to occupy only a single corner of the cut-out triangular pivot point.

14. The overhead door locking device of claim 7, wherein the pin is removable from the double-headed pawl and release mechanism.

15. The overhead door locking device of claim 7, wherein the pin comprises metal.

16. The overhead door locking device of claim 1, wherein an angle between the double-headed pawl and a back wall of the cut-out triangular pivot point is less than 90 degrees in a locked position.

17. The overhead door locking device of claim 1, wherein the release mechanism is attachable to an operating arm.

18. A method of using an overhead door locking device to secure an overhead door in a desired position comprising:
lifting a release mechanism such that a double-headed pawl is pulled upwards, and a pin connecting the double-headed pawl and the release mechanism rises to a top point of a cut-out triangular pivot point;
applying force to an overhead door such that the overhead door is pushed upwards or pulled downwards;
releasing the release mechanism such that it rests lightly on a rotating gear but does not engage any teeth in the gear;
allowing the overhead door to come to a stop, either by exhausting the energy resulting from the applied force, or by holding the overhead door such that it stops in a desired position;
allowing the gear to slow to a stop such that the double-headed pawl engages with the teeth of the gear; and
allowing the double-headed pawl to be pushed to one side until it abuts a back wall of the cut-out triangular pivot point.

19. The method of claim 17, wherein lifting a release mechanism comprises pulling on an operating arm.
